(19) United States
(12) Patent Application Publication
(10) Pub. No.: US 2009/0083375 A1
(43) Pub. Date: Mar. 26, 2009

(54) Installation of a Virtualization Environment

(76) Inventors: Benedict T. Chong, San Jose, CA (US); Mark M. Lee, Saratoga, CA (US); Philip Sheu, San Jose, CA (US); Thomas Deng, Cupertino, CA (US); Victor E. Chin, San Jose, CA (US)

Correspondence Address: GLENN PATENT GROUP, 3475 EDISON WAY, SUITE L, MENLO PARK, CA, 94025, US

(21) Appl. No.: 12/239,701

(22) Filed: Sep. 26, 2008

Related U.S. Application Data
(63) Continuation-in-part of application No. 12/200,758, filed on Aug. 28, 2008.
Application No. 12/200,758 is a continuation of application No. 11/772,700, filed on Jul. 2, 2007, now Pat. No. 7,441,113.
(60) Provisional application No. 60/975,724, filed on Sep. 27, 2007.
(60) Provisional application No. 60/806,915, filed on Jul. 10, 2006.
(60) Provisional application No. 60/890,121, filed on Feb. 15, 2007.

(51) Int. Cl. G06F 9/445; G06F 15/16; H04L 9/32; G06F 12/16; G06F 17/30

(52) U.S. Cl. 709/203; 707/3; 717/176; 726/17; 707/204; 707/E17.014

(57) ABSTRACT

The invention provides a method and apparatus for downloading a Virtualization Environment comprising an electronic programming guide (EPG) and an appliance environment onto a client. The EPG is launched from boot files stored in the hard disk or other boot media. The EPG comprises a user interface (UI) that is displayed to the user. The EPG UI comprises a plurality of icons that are graphical representations of virtual appliances. The EPG UI can also include a search entry field. A user can enter text into the search entry field and launch a search engine to obtain search results. The virtual appliances can be stored locally, for example on a hard drive or peripheral device, or they can be stored on a download server. The download server also contains the virtualization environment installer. An installation server scans the client to determine if the client contains the proper hardware and drivers for running the virtualization environment. A persistent storage server can store a user's personal information.

### CROSS REFERENCE TO RELATED APPLICATIONS

This patent application is a continuation-in-part of U.S. patent application Ser. No. 12/200,758, Method and Apparatus for Virtualization of Appliances, filed Aug. 28, 2008, which is a continuation of U.S. patent application Ser. No. 11/772,700, Method and Apparatus for Virtualization of Appliances, filed Jul. 2, 2007 and claims priority to U.S. provisional patent application Ser. No. 60/806,915, Method and Apparatus for Virtualization of Applications, filed Jul. 10, 2006; U.S. provisional patent application Ser. No. 60/890,121, Instant On Appliances, filed Feb. 15, 2007; and U.S. provisional patent application Ser. No. 60/975,724, Quick Searching Facility for a Virtualized Environment, filed Sep. 27, 2007, the entirety of each of which is incorporated herein by this reference thereto.

### BACKGROUND OF THE INVENTION

1. Technical Field

The invention relates to virtualization. More particularly, the invention relates to a method and apparatus for downloading virtualization software.

2. Description of the Prior Art

In computing, virtualization is a broad term that refers to the abstraction of computer resources. One useful definition is a technique for hiding the physical characteristics of computing resources from the way in which other systems, applications, or end users interact with those resources. This term has been widely used since the 1960s or earlier, and has been applied to many different aspects and scopes of computing, from entire computer systems to individual capabilities or components. The common theme of all virtualization technologies is the hiding of technical detail, through encapsulation. Virtualization creates an external interface that hides an underlying implementation, e.g. by multiplexing access, by combining resources at different physical locations, or by simplifying a control system.

VMWare designed the VMWare Player to run multiple operating systems concurrently. Specifically, a virtual machine monitor (VMM) is co-resident with the host operating system and converts calls from the host operating system for use with the VMM. See, for example, U.S. Pat. Nos. 6,397,242; 6,496,847, 6,704,925. Thus, because the VMWare Player must translate calls from the host operating system to the secondary operating system, the processing time is increased. The VMWare Player can be downloaded.

### SUMMARY OF THE INVENTION

The invention provides a method and apparatus for downloading virtualization software. In one embodiment, the Virtualization Environment installer scans the user's computer to determine if it satisfies the device driver requirements. If the computer has sufficient drivers, the installer downloads the appliance files and saves the Virtualization Environment files to the Windows hard disk in the filesystem, i.e. NTFS. The user information is stored on a persistent storage server to avoid writing to the NTFS.

The Virtualization Environment includes an electronic programming guide (EPG). The EPG is similar to a set-top box in that it is easy and intuitive to use. When the system boots, the EPG user interface (UI) is the first image a user sees. The EPG displays all available virtual appliances from, for example, the following places: peripheral device such as a thumb drive, USB, flash card, e.g. SD, xD, CF, CDROM/DVD, or other storage media; local hard disk storage; and the Internet, e.g. a download server. In one embodiment, the EPG UI includes a search entry field for entering search terms.

The user selects an appliance to use from the EPG and the appliance is loaded and launched. If the selected appliance is not accessible locally, then it is downloaded, e.g. over the Internet from a download server. The user can also elect to boot the host OS from the hard disk, if a host OS and hard disk are installed, or to power-off the system.

In one embodiment, the EPG is displayed for a certain time period. If a user does not take action during that time, the computer reverts back to the default procedure by booting the host OS.

In one embodiment, the appliance is an application on a Linux operating system. When the user selects an appliance to use from the EPG, the latter boots Linux and passes the appliance name to Linux. Once Linux is booted up, the appliance is loaded and launched.

### BRIEF DESCRIPTION OF THE DRAWINGS

FIG. 1 is a flow chart that illustrates the steps for downloading and installing the Virtualization Environment software according to one embodiment of the invention;

FIG. 2 is a block diagram of the system for implementing a Virtualization Environment according to one embodiment of the invention;

FIG. 3 is a flow chart that illustrates the steps for using the Virtualization Environment where the host OS is Windows according to one embodiment of the invention; and

FIG. 4 is an example of an EGP user interface according to one embodiment of the invention.

### DETAILED DESCRIPTION OF THE INVENTION

In one embodiment, the invention comprises a method and/or an apparatus for installing virtualization software called a Virtualization Environment, which runs on a Virtualization Environment operating system (OS), e.g. Linux.

The Virtualization Environment provides the user with all the functionality associated with a host OS, without having to wait for the host OS to load. The virtualization software comprises an Electronic Programming Guide (EPG), which uses boot files stored on the host OS and which suspends the host OS once the EPG is launched. The EPG comprises a user interface (UI) that displays icons as graphical representations of the appliances. When the user selects an appliance for launching, the personal computer becomes a dedicated function device for the selected appliance. Thus, in a matter of seconds, a user can launch any of the following: a browser for surfing the Internet, an instant messaging client, a Voice over Internet Protocol (VoIP) system, an MP3 player, etc.

### Installation of the Virtualization Environment Files

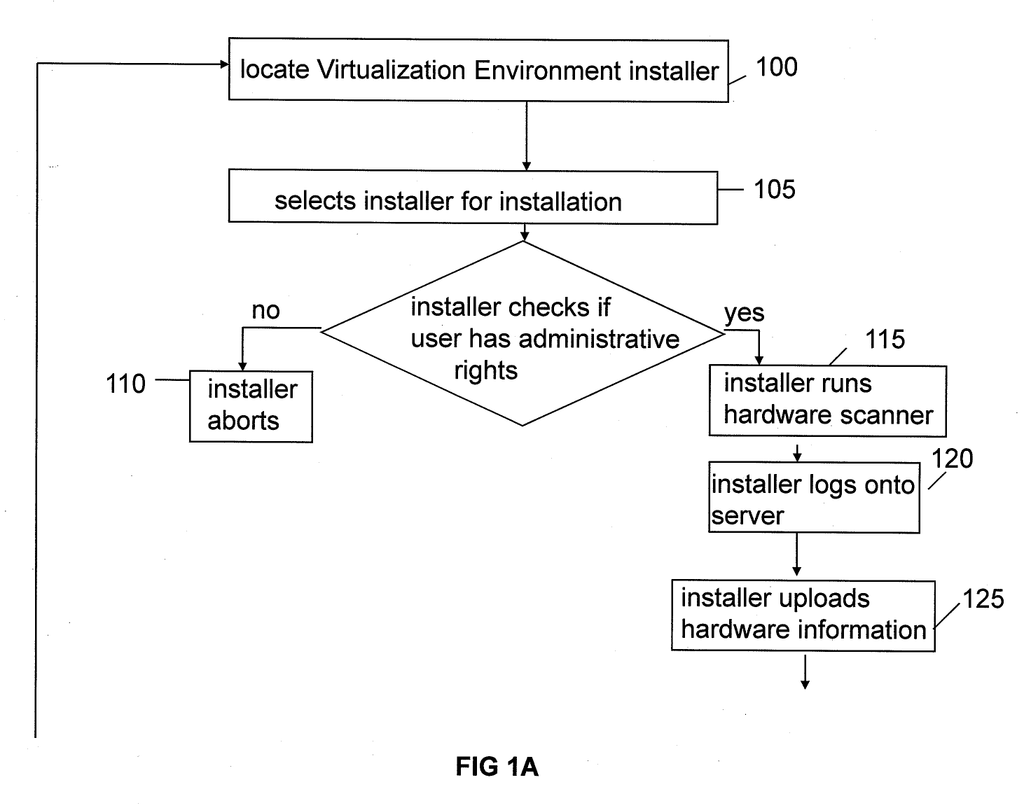

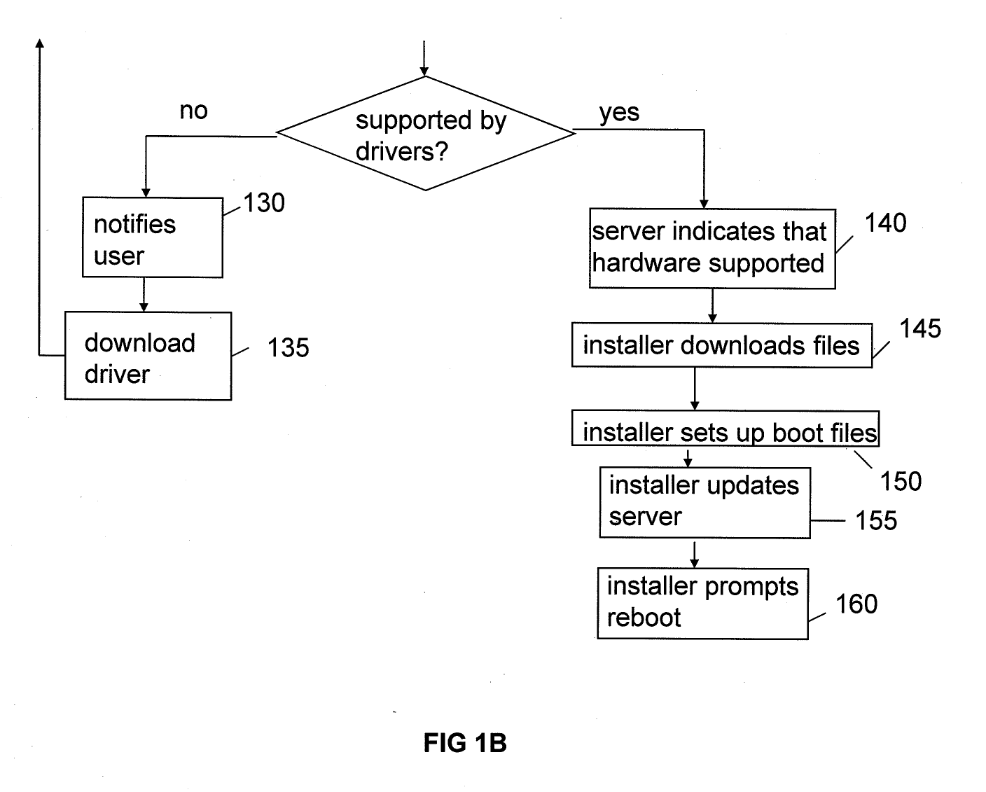

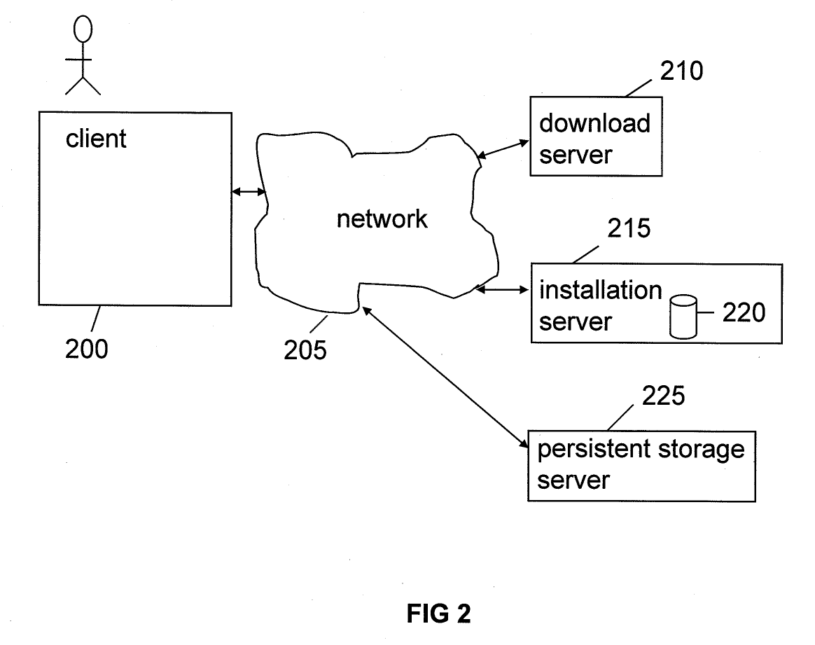

FIG. 1 is a flowchart that illustrates the steps for downloading and installing the Virtualization Environment software using a Virtualization Environment installer according to one embodiment of the invention. FIG. 2 is a block diagram of the system for implementing a Virtualization Environment.

A user uses a client 200, e.g. a computer platform configured to act as a client device such as a computer, a digital media player, a personal digital assistant, or a cellular telephone to locate 100 the Virtualization Environment installer on a download server 210 for downloading via a network 205, e.g. the Internet, a local area network (LAN), a wide area network (WAN). The Virtualization Environment installer can be downloaded directly from, for example, DeviceVM's website, e.g. the website for Splashtop™ software or from a website dedicated to providing a repository of applications for download.

The user selects 105 the Virtualization Environment installer for installation on a client 200. The installer assesses whether the user has administrative rights. If not, the installer aborts 110. If the user has administrative rights, the installer runs 115 a hardware scanner to identify device drivers on the client. The device driver functions as a translator between hardware and the application or the OS that uses the hardware. Thus, without the appropriate drivers, the hardware is useless.

The Virtualization Environment includes a virtual appliance, called the electronic programming guide (EPG), which comprises a user interface (UI) that is displayed on the client 200. The EPG requires the following hardware items: a video controller, mouse, keyboard, on-screen mouse cursor, and hard disk controller. The hard disk controller is important for compatibility because it allows the central processing unit (CPU) to communicate with a storage device. Newer systems use Serial AT Attachment (SATA) native interfaces.

The appliance environment, which launches the virtual appliances, has the same hardware requirements as the EPG. In addition, the appliance environment requires a network controller for either wired or wireless networks, a CDROM/DVD interface, audio hardware, and a USB or memory card interface. The CDROM/DVD interface is important for music, and video playback appliances. The USB or memory card interface is important for photo and music appliances. In one embodiment, the appliance environment runs on Linux.

The installer logs 120 onto the installation file server 215. The installer uploads 125 the hardware configuration information to the installation file server 215. The installation file server 215 includes a database 220 backend that associates hardware information with the Virtualization Environment files. The installation file server 215 determines which Virtualization Environment kernel binaries support the specific network controller contained on the client. If the client lacks sufficient device drivers, the Virtualization Environment installer notifies 130 the user. The user can download 135 the drivers from a download server 210 and restart the installation process by locating 100 the Virtualization Environment installer. Alternatively, the drivers can automatically be downloaded by the Virtualization Environment installer.

If the client contains the proper drivers and hardware, the server indicates 140 that the hardware is supported. If the hardware is supported, the installer downloads 145 the files to the local hard disk, e.g. in C:\Appliance. One of the files includes a utility that runs every time the OS boots. The installer sets up 150 the boot files. The original files, ntldr for Windows XP or bootmgr for Windows Vista, are renamed ntldr.dvm or bootmgr.dvm. These new versions of the files replace the originals. The installer updates 155 the installation server 215 with the status of the installation process. The installer prompts 160 the user to reboot.

### Electronic Program Guide (EPG)

The Virtualization Environment comprises an EPG, which may be included in the system boot ROM. The EPG is a virtual appliance that comprises a user interface for displaying other appliances to a user. The EPG is similar to those provided with a set-top box in that it is easy and intuitive to use. In one embodiment, the EPG comprises a switching mechanism, such as a docking panel, application launch bar, scroll bar, soft keys, or physical buttons.

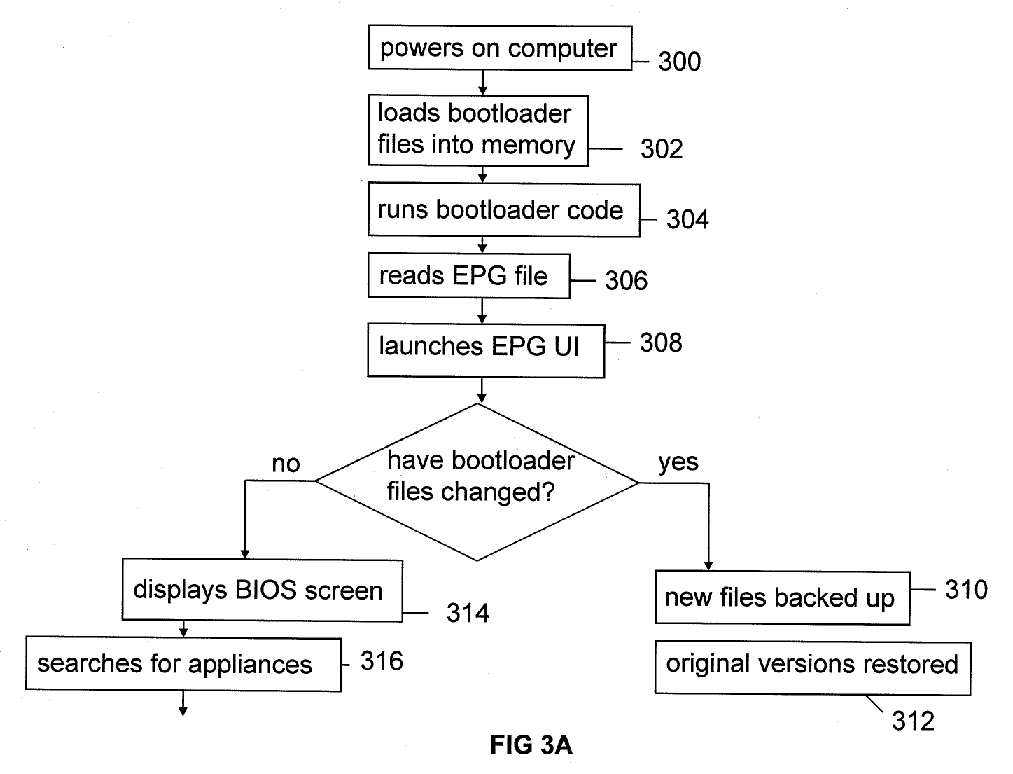

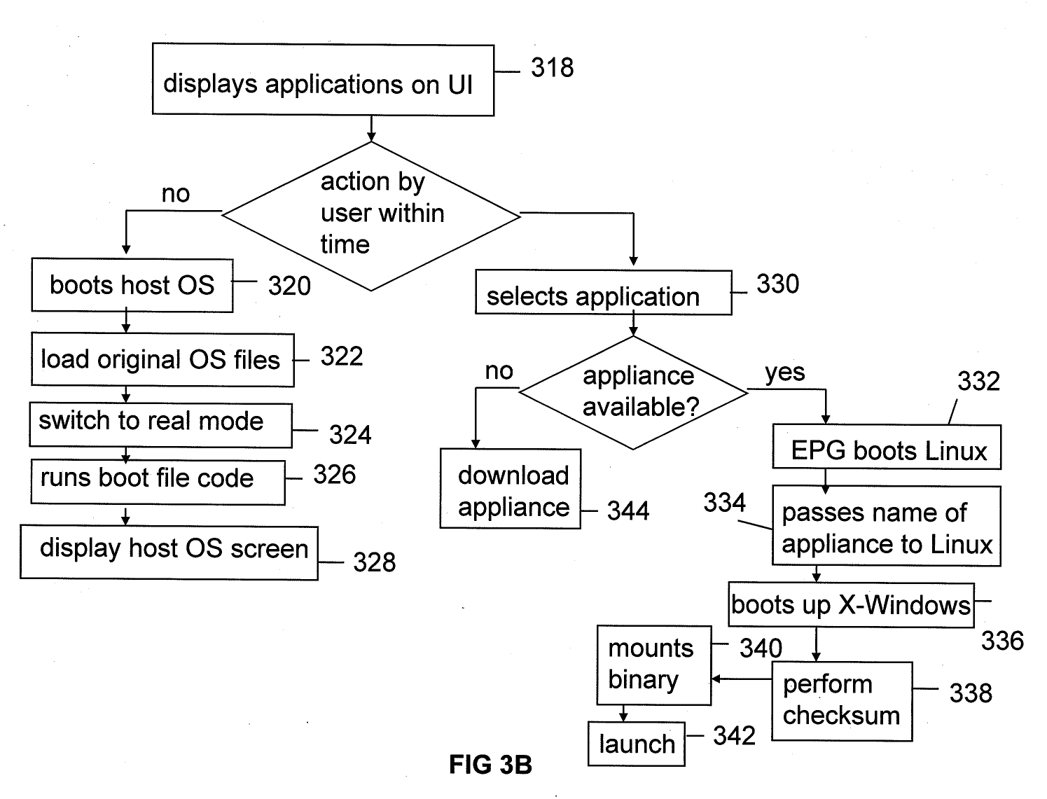

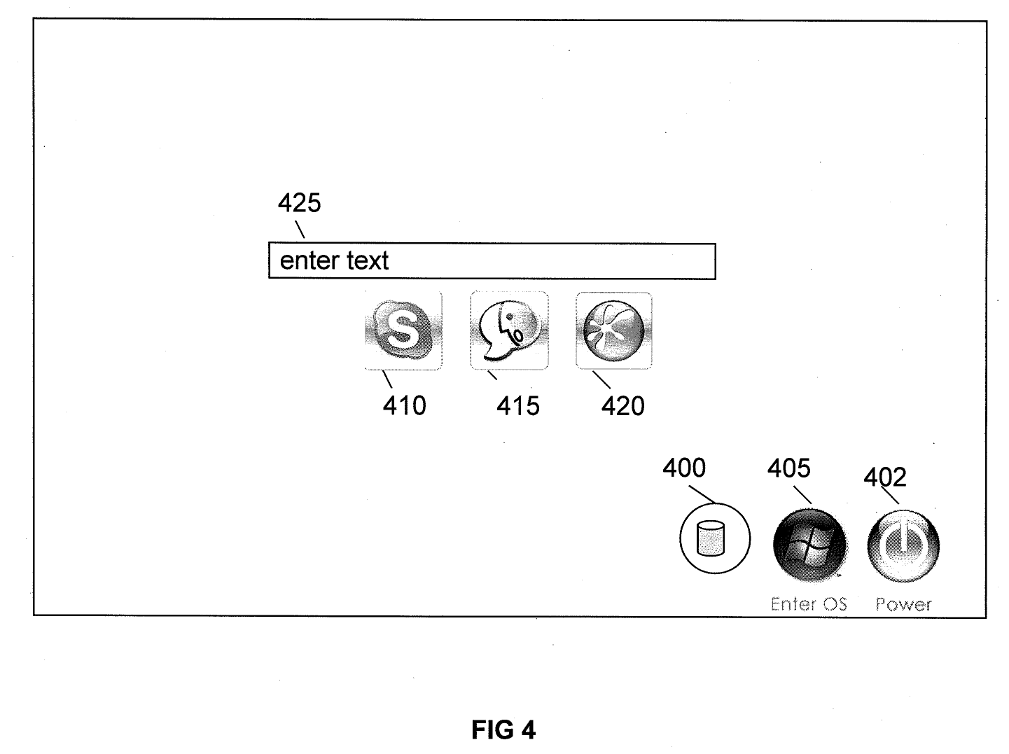

FIG. 3 is a flow chart that illustrates the steps for loading and using the EPG on a client 200 running Microsoft Windows as the host OS according to one embodiment of the invention. First, the user powers on 300 the computer. The boot files as described in FIG. 1 reside on the file system for the Windows OS, i.e. the NTFS file system. The Windows boot sector code loads 302 the bootloader file into memory and runs 304 the bootloader code. The bootloader code reads 306 the EPG file from the NTFS file system into memory and launches 308 the EPG UI. FIG. 4 is an example of an EPG UI according to one embodiment of the invention.

This two-step boot process is used because the Windows boot sector code can only load and launch real-mode code and because the EPG code runs in high memory with the CPU in protected code. The ntldr and bootmgr files may contain different code because of NTFS differences between Windows XP and Vista.

To avoid having to write to the NTFS file system or to store data locally, persistent data is stored on a persistent storage server 225. Persistent data includes, e.g. browser bookmarks, user data, etc. The persistent storage server communicates with a driver in the Linux environment. The driver maps an online storage space to a folder or device in the Linux environment.

If an appliance is enabled for persistent storage, the user logs into the persistent storage server 225 to access the user's personal data. The user selects a persistent storage icon 400 on the EPG UI to bring up the log-in dialog box. The log-in dialog box does not automatically appear because the user may not need to access persistent storage every time the Virtualization Environment is used.

The persistent storage icon 400 is part of a tool bar that can also include other icons, such as a power-off icon 402, which allows users to shut down the client 200. The tool bar can also include a reboot icon (not shown) to reboot the computer, a volume control icon (not shown) to control the client's 200 volume, and a network advanced configuration icon (not shown) for proxy server, static IP setup, etc.

When Windows is updated, it can replace the new ntldr or bootmgr files. Thus the system determines if the bootloader files have changed to prevent Windows from disabling the Virtualization Environment. If the bootloader files have changed, the new files are backed up 310 and the original Virtualization Environment versions of the bootloader files are restored 312.

If the bootloader files have not changed, the client 200 displays 314 a BIOS boot screen. The Virtualization Environment searches 316 for all available virtual appliances from, for example, local USB, flash card, e.g. SD, xD, CF, CDROM/DVD, or other storage media; local hard disk storage; Internet, e.g. a download server 210. The EPG displays 318 appliances on the EPG UI. At this point, the mouse and keyboard are activated and available to the user. Once the EPG UI is displayed, a timer begins counting-down.

If the user does not take an action, e.g. select an appliance, move the cursor, etc., or if the user selects the host OS icon 405 on the EPG UI, the EPG boots 320 to Windows by loading 322 the original boot files, e.g. ntldr/bootmagr for Windows XP and Vista, respectively. The client 200 switches 324 to real mode and runs 326 the ntldr/bootmgr code. The client displays 328 the host OS boot screen. The steps that follow if a user does select 330 an appliance, are described below.

Although the download server 210, installation server 220, and persistent storage server 225 are illustrated as separate components, in one embodiment, these components can reside on the same server or a combination of servers.

### Appliance

An appliance, or virtual appliance, is a self-contained binary package that contains everything that is necessary to perform a particular task. The virtual appliances can include, for example, a VoIP application, an instant messenger, a browser, a search engine, an MP3 player, a CD player, a DVD player, a video player, or a photo application. For example, a VoIP appliance contains all the software necessary for the user to connect to the Internet and then talk with another party. Such an appliance may contain an OS, network stack, device drivers, user interface, and a VoIP application.

Referring back to FIG. 3, if the user does select 330 an appliance to use, e.g. the Skype appliance icon 410, the chat icon 415, or load the Splashtop™ browser 420, the EPG determines whether the appliance is available. If the appliance is available, for example, in local storage, the EPG boots 332 Linux. The EPG passes 334 the name of the appliance to the Linux kernel. Linux boots up 336 to an X-windows environment. The startup scripts mount the hard disk and look into the appliance directory, e.g. C:\Appliance for the appliance binary file. The appliance binary file can be a compressed file system archive, e.g. squashfs or unionfs. The startup script performs 338 a checksum validation on the application binary. The startup script mounts 340 the application binary file and launches 342 the appliance application.

In one embodiment, the startup sequence is optimized to achieve a quick boot. One optimization approach involves improving concurrency by performing the operations of decompressing and executing while the appliance is being loaded. To do this, a compression algorithm optimized for streaming media is used. At the top level, the appliance is streamed to the personal computer. The stream is made up of compressed chunks. Each chunk can be decompressed independently of the other chunks.

In one embodiment, the EPG downloads 344 additional appliances. The user can manually download a self-extracting file from the download server 210 using a web browser and then select the self-extractor to run. The self-extractor copies files to the correct location on the hark disk.

In another embodiment, the download application can be specially written. The download application communicates with the download server 210, lists the appliances that are available to the user on the EPG UI, and downloads the appliance binaries to the correct location on the hard disk. The application performs a checksum and other validation steps to ensure that the downloaded appliance is free of malware.

In one embodiment of the invention, a user can perform an Internet search by entering text directly into the search entry field 425. The user then selects the Splashtop™ browser 410 to launch the search. The Splashtop™ browser uses Firefox to perform the searches. Further details, and various embodiments of the searching mechanism are described in U.S. patent application, Quick Searching UI for a Better User Experience, filed Sep. 26, 2008, and which is incorporated herein, in its entirety by this reference thereto.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A system comprising:
a client, said client comprising:
a display device;
a host operating system (OS);
an electronic programming guide (EPG) launched by a plurality of boot files stored in said host OS, wherein launching of said EPG suspends said host OS, said EPG comprising:
a user interface (UI) that is presented to said user on said display, said EPG UI comprising at least one icon, said icon comprising a graphical representation of a virtual appliance;
an appliance environment comprising a virtual environment OS for accessing and launching said virtual appliance in response to a selection of said at least one icon on said EPG UI;
a download component for providing any of a plurality of said virtual appliances and a plurality of virtualization environment installation files in response to a request by said client; and
an installation component for storing compatibility information about hardware and device drivers that are required for running said EPG, said appliance environment, and said virtual appliance and for suspending said host OS.

2. The system of claim 1, wherein said virtual appliances are stored on at least one of a local hard disk and a peripheral device.

3. The system of claim 2, wherein said peripheral device comprises at least one of a thumb drive, USB, flash card, compact disc, and DVD.

4. The system of claim 1, further comprising:
a persistent storage server for storing user data.

5. The system of claim 4, wherein said user data on said persistent storage server comprises at least one of bookmarks, search history, and user preferences.

6. The system of claim 1, further comprising:
a search engine appliance;
said EPG UI further comprising a search entry field for accepting user input of at least one character pursuant to a search in conjunction with said search engine appliance.

7. A computer implemented method for installing a virtualization environment on a client, comprising the steps of:
locating a virtualization environment installer for installing said virtualization environment, said virtualization environment comprising an electronic programming guide (EPG) for suspending a host operating system (OS) once a plurality of boot files for said EPG are launched and for displaying a plurality of icons on a user interface to a user, said icons representing at least one virtual appliance, and an appliance environment for launching said at least one virtual appliance using a virtualization environment OS;
running a hardware scanner on said client to obtain a list of said client's hardware and drivers to determine if said client's hardware and drivers are compatible with said virtualization environment program;
logging into an installation server;
uploading said hardware and driver information to said installation server;
said installation server determining whether said client comprises hardware and drivers that are compatible with said virtualization environment;
downloading a set of drivers that are compatible with said client hardware to said client if said client requires said drivers;
downloading a virtualization environment installer to said client;
saving said plurality of virtualization environment boot files to said host OS; and
updating said installation server with installation information.

8. The method of claim 7, further comprising the step of:
determining if a user has administrative rights; and
aborting said method for installing said virtualization environment if said user does not have administrative rights.

9. The method of claim 7, further comprising the step of:
installing said virtualization environment while said host OS is running.

10. A computer readable storage medium comprising computer executable instructions, the instructions when executed causing an application to perform the steps of:
loading a plurality of virtualization environment bootloader files into a memory, said plurality of bootloader files stored on a host operating system (OS);
running a virtualization environment bootloader code;
launching an electronic programming guide (EPG), said EPG suspending said host OS;
displaying an EPG user interface (UI) to a user, said EPG UI comprising at least one icon, said at least one icon comprising a graphical representation of at least one virtual appliance;
upon selection of said at least one icon, booting a virtualization environment OS;
passing a name of said virtual appliance to said virtualization environment OS; and
said virtualization environment OS launching said virtual appliance.

11. The computer readable storage medium of claim 10, further comprising the step of:
determining if said bootloader files changed upon subsequent powering of said client.

12. The computer readable storage medium of claim 10, further comprising the steps of:
upon determining that said bootloader files changed, backing up said bootloader files; and
restoring said original versions.

13. The computer readable storage medium of claim 10, further comprising the step of:
upon selection of said at least one icon for launching said virtual appliance, determining if said virtual appliance is stored locally.

14. The computer readable storage medium of claim 13, further comprising the step of:
downloading said virtual appliance from a download server if said virtual appliance is not stored locally.

15. The computer readable storage medium of claim 10, further comprising the step of:
establishing a timer once said EPG UI is displayed;

16. The computer readable storage medium of claim 15, further comprising the steps of:
upon expiration of said timer, booting said host OS;
loading a plurality of original host OS files;
switching to real mode;
running boot file code; and
displaying said host screen.

17. The computer readable storage medium of claim 10, said EPG UI further comprising any of an icon for booting said host OS, an icon for powering down said client, an icon for rebooting said client, an icon for controlling volume of said client, and a network advanced configuration icon.

18. The computer readable storage medium of claim 10, wherein said virtual appliances comprise any of a browser, a search engine, an instant messenger, an MP3 player, a CD player, a DVD player, a video player, a Voice over IP application, and a photo application.

19. The computer readable storage medium of claim 10, wherein said virtual applications are stored on any of local USB, flash card, local hard disk, and a download server.

20. The computer readable storage medium of claim 10, wherein said Virtual Environment OS launches said virtual appliance with the following steps:
launching an X-Windows environment;
mounting a hard disk and searching said hard disk for a virtual appliance binary file corresponding to said virtual appliance;
performing a checksum validation on said virtual appliance binary file;
mounting said binary file; and
launching said virtual appliance.
